(19) United States
(12) Patent Application Publication
(10) Pub. No.: US 2008/0137519 A1
(43) Pub. Date: Jun. 12, 2008

(54) Multi-channel optical communication lens system and optical module using the same

(75) Inventor: Yoshiaki Ishigami, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/979,551

(22) Filed: Nov. 5, 2007

(30) Foreign Application Priority Data
Nov. 6, 2006 (JP) 2006-300480

(51) Int. Cl. G11B 7/00

(52) U.S. Cl. 369/112.24

(57) ABSTRACT

A multi-channel optical communication lens system, which is disposed between a plurality of arranged optical transmission lines and a plurality of photoelectric elements which is arranged facing respective ones of the optical transmission lines and transmit or receive optical signals, and which couples the optical signals between each of the optical transmission lines and each of the photoelectric elements thereto respectively, includes a first convex lens disposed at a location which makes the optical signals focus on end faces of the arranged optical transmission lines or a vicinity thereof, and a second convex lens disposed at a location which makes the optical signals focus on the photoelectric elements. Both of the first and second convex lenses includes an aspherical surface on one side thereof and a nonaxisymmetric aspherical surface on another side thereof.

The present application is based on Japanese Patent Application No. 2006-300480 filed on Nov. 6, 2006, the entire contents of which are incorporated herein by reference.

### BACKGROUND OF THE INVENTION

1. Field of the Invention

This invention relates to a multi-channel optical communication lens mounted in an optical module which transmits or receives a multi-channel optical signal, and to an optical module using the same.

2. Description of the Related Art

At a terminal of an optical communication system, an optical module which transmits an optical signal converted from an electrical signal, to an optical transmission line such as an optical fiber, or which receives an optical signal from the optical transmission line, is used.

More specifically, the optical module including a laser diode (LD) array or a photo diode (PD) array is used so as to transmit or receive a plurality of optical signals. Such an optical module includes a multi-channel optical communication lens coupling the optical signals between the optical transmission line and the LD or the PD.

As shown in FIG. 4, a multi-channel optical communication lens 40 is disposed between a plurality of optical fibers 41 (e.g., optical fiber array 42) and a plurality of PDs 43 (e.g., PD array 44), and couples optical signals outputted from each of the optical fibers 41 to each of the PDs 43, respectively. The multi-channel optical communication lens 40 is a micro lens array which includes a plurality of micro lenses 46 and 47 formed in parallel so as to face each of the optical fibers 41 and each of the PDs 43.

The optical signals outputted from each of the optical fibers 41 are collimated by the optical fiber side micro lens 46. The collimated optical signals (parallel light) are collected by the PD side micro lens 47 and received by each of the PDs 43 at a focal point. Since in the optical module including the multi-channel optical communication lens 40, the micro lenses 46 and 47 are formed for each pair of the optical fiber 41 and the PD 43 corresponding thereto, the optical signal from each of the optical fibers 41 can be respectively coupled to each of the PDs 43.

JP-A-2005-292739 discloses a conventional multi-channel optical communication lens.

The conventional multi-channel optical communication lens 40 mounted in the optical module has a relatively small lens diameter so as to dispose a plurality of micro lenses 46 and 47 in parallel, and to collimate and collect a plurality of optical signals respectively. Consequently, focal lengths of the micro lenses 46 and 47 are relatively short, and the lens 40 must be disposed in the vicinity of the PD, the LD, and an optical connector, etc., when the lens 40 is mounted in the optical module. Therefore, a structure (and design) of the optical module including a LD package or a PD package is limited.

Further, in the micro lens array having a relatively short focal length, contaminants (e.g., dust or dirt) may attach to a convex lens and cause a degradation of the optical signal being transmitted through the convex lens. That is, the diameter of the convex lens of the micro lens array is small, and the contaminant is large compared to the lens diameter (diameter of the optical signal). The degradation of the optical signal caused by the contaminant can be solved by using a relatively large-aperture lens which has a lens diameter greater than that of the micro lens.

However, although the relatively large-aperture lens is applied to the multi-channel optical communication, the large-aperture lens can be applied only to an optical signal of not more than four (4) channels. If a large lens is used with an optical signal having more than four (4) transmission channels, then it is impossible to reduce a spot size and collect the optical signal. Thereby, when the optical signal is coupled to the PD, a loss becomes greater.

Thus, prior to the present invention, there has been no conventional system or method which can provide a multi-channel optical communication lens and an optical module using the same, which can make the optical module having an LD or a PD by a desired structure, and can couple a multi-channel optical signal with a low loss.

### SUMMARY OF THE INVENTION

In view of the foregoing and other exemplary problems, drawbacks, and disadvantages of the conventional methods and structures, an exemplary feature of the present invention is to provide a multi-channel optical communication lens and an optical module using the same.

According to one exemplary aspect of the invention, a multi-channel optical communication lens, which is disposed between a plurality of arranged (e.g., ordered) optical transmission lines and a plurality of photoelectric elements which is arranged facing respective ones of the optical transmission lines and transmit or receive optical signals, and which couples the optical signals between each of the optical transmission lines and each of the photoelectric elements thereto respectively, includes:

a first convex lens disposed at a location which makes the optical signals focus on end faces of the arranged optical transmission lines or a vicinity thereof; and

a second convex lens disposed at a location which makes the optical signals focus on the photoelectric elements,

wherein both of the first and second convex lenses include an aspherical surface on one side thereof and a nonaxisymmetric aspherical surface on another side thereof.

According to another exemplary aspect of the invention, an optical module, includes:

a plurality of arranged optical transmission lines;

a plurality of photoelectric elements which is arranged facing respective ones of the optical transmission lines and transmit or receive optical signals;

a first convex lens disposed at a location which makes the optical signals focus on end faces of the arranged optical transmission lines or a vicinity thereof; and

a second convex lens disposed at a location which makes the optical signals focus on the photoelectric elements,

wherein both of the first and second convex lenses include an aspherical surface on one side thereof and a nonaxisymmetric aspherical surface on another side thereof.

### ADVANTAGES OF THE INVENTION

According to the present invention, the optical module having an LD or a PD can be made by a desired structure, and that a multi-channel optical signal can be coupled with a low loss.

The above exemplary modifications may be made alone or in any combination thereof.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is a pattern diagram showing a meridian plane of a multi-channel optical system diode 10 in an exemplary embodiment according to the present invention;

FIG. 2A is a view (pattern diagram showing a spherical segment) taken along a line 2A of FIG. 1.

FIG. 2B is an enlarged view showing a part surrounded by a circle in FIG. 2A.

FIG. 3A is a pattern diagram showing a spherical segment of a conventional multi-channel optical communication lens;

FIG. 3B is an enlarged view showing a part surrounded by a circle in FIG. 3A; and

FIG. 4 is a pattern diagram showing a conventional multi-channel optical communication lens 40.

### DETAILED DESCRIPTION OF THE EXEMPLARY EMBODIMENTS

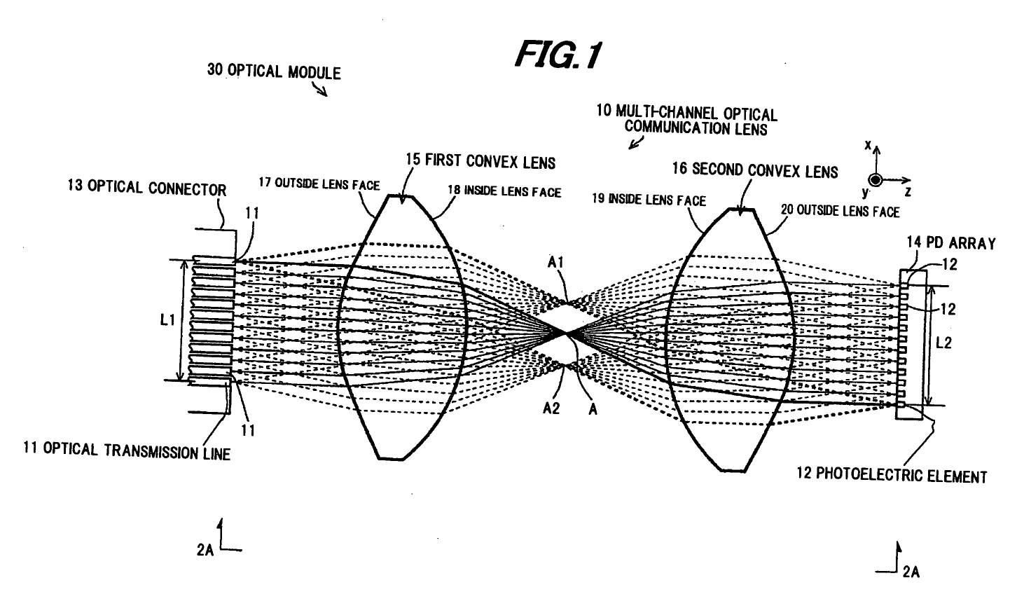

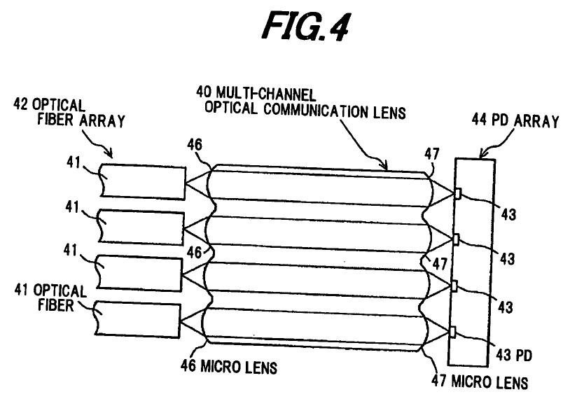

Referring now to the drawings, and more particularly to FIGS. 1-4, there are shown exemplary embodiments of the methods and structures according to the present invention.

### Exemplary Embodiment 1

Hereinafter, an exemplary embodiment of the present invention will be concretely described with reference to the drawings.

FIG. 1 is a pattern diagram showing an exemplary embodiment of a multi-channel communication lens component according to the present invention.

As shown in FIG. 1, a multi-channel optical communication lens 10 of this exemplary embodiment is disposed between a plurality of arranged (e.g., ordered) optical transmission lines 11 constituting an optical module 30 (e.g., optical transceiver) and multiple photoelectric elements 12 which are arranged facing respective ones of the optical transmission lines 11 and transmit or receive optical signals. The multi-channel optical communication lens 10 couples the optical signals between each of the optical transmission lines 11 and each of the photoelectric elements 12 thereto respectively.

A plurality of optical fibers are exemplarily used as the plural optical transmission lines 11. In this exemplary embodiment, twenty (channels) optical fibers are disposed (arranged) in parallel, and an optical connector 13 (e.g., MT (Mechanically Transferable) optical connector for a twelve core tape fiber) is formed at input/output terminals of the optical fibers. A distance between the optical fibers may be a pitch of 250 μm and a distance L1 between both ends of the optical fibers 11 may be 2.75 mm.

A plurality of photo diodes (PD) are exemplarily used as the multiple photoelectric elements 12. In this exemplary embodiment, PD array 14 in which a plurality of PDs (e.g., 10 Gbit/s transmission, 50 μm of light-receiving diameter) are exemplarily arranged by a 250 μm pitch in parallel, is used. An exemplary distance between the optical photoelectric elements 12 may be a pitch of 250 μm and a distance L2 between both ends of the photoelectric elements 12 may be 2.75 mm.

The multi-channel optical communication lens 10 includes two convex lenses 15 and 16 facing each other. One convex lens (hereinafter, a “first convex lens”) 15 is disposed so as to face the plural optical transmission lines 11, and another convex lens (“second convex lens”) 16 is disposed so as to face the plural optical photoelectric elements 12. Further, an effective lens diameter of the first convex lens 15 may be greater than the distance L1 between the both ends of the optical transmission lines 11 which are most distant from each other with respect to the plural optical transmission lines 11 arranged in parallel. An effective lens diameter of the first convex lens 16 may be greater than the distance L2 between both ends of the optical photoelectric elements 12 which is most distant from each other with respect to the plural optical photoelectric elements 12 arranged in parallel.

The first convex lens 15 and the second convex lens 16 may be formed of an optical resin by metal molding. The optical resin used as a lens material may be, for example, an acrylic resin (e.g., methyl methacrylate resin), a PC (polycarbonate), and/or a COP (Cyclo Olefin Polymer). Further, when taking into account a material strength or heat resistance, a PEI (polyetherimide) as a super engineering plastic may be appropriate. Any of these optical resins can be used for the multi-channel optical communication lens 10 of this exemplary embodiment.

In this case, a lens face 17 at a side of the optical transmission lines 11 of the first convex lens 15 and a lens face 20 at a side of the photoelectric elements 12 of the second convex lens 16 are designated as an “outside lens face”. A lens face 18 at an opposite side of the optical transmission lines 11 of the first convex lens 15 and a lens face 19 at an opposite side of the photoelectric elements 12 of the second convex lens 16 are designated as an “inside lens face”.

In this exemplary embodiment, the outside lens face 17 of the first convex lens 15 and the outside lens face 20 of the second convex lens 16 are formed to have the same curved surface. The inside lens face 18 of the first convex lens 15 and the inside lens face 19 of the second convex lens 16 are formed to have the same curved surface. Further, other configurations (e.g., material (refractive index) of the optical resin, distance between the inside lens face and the outside lens face) of the first convex lens 15 and the second convex lens 16 other than the lens faces 17-20 are also formed substantially identically.

In the multi-channel optical communication lens 10 of this exemplary embodiment, the first convex lens 15 and the second convex lens 16 are disposed in the optical module 30 so that end faces of the arranged optical transmission lines 11 or a vicinity thereof and the photoelectric elements 12 are located at the light focusing points of the first convex lens 15 and the second convex lens 16. The inside lens faces 18 and 19 of the first convex lens 15 and the second convex lens 16, which are facing each other, are formed to have nonaxisymmetric lens faces (toric surface) so as to reduce an astigmatism from each of the optical transmission lines 11 to each of the photoelectric elements 12.

The nonaxisymmetric lens face may be a lens face formed with curves different from each other with respect to a meridian plane (cross section of a meridian line direction, x direction in the figures) of the lens face and a spherical segment (cross section of a spherical segment line direction, y direction in the figures). Especially, parameters such as a curvature, an elliptical constant, and/or an aspherical constant, etc., are different from each other.

The optical module 30 using the multi-channel optical communication lens 10 includes a plurality of optical transmission lines 11 arranged in parallel, and a plurality of photoelectric elements 12 arranged in parallel. A receiving optical module including a PD as the photoelectric element 12, a transmitting optical module including a laser diode (LD) as the photoelectric element 12, and a transmitting/receiving optical module (e.g., optical transceiver) including both the PD and the LD are used as the optical module 30. With respect to the transmitting/receiving optical module, for example, the same number of the PDs and LDs are disposed as the photoelectric element 12.

Hereinafter, operations of this exemplary embodiment are described.

In FIG. 1, a primary ray (light axis of a spherical aberration) of an optical signal propagating through the first convex lens 15 and the second convex lens 16 is illustrated by a solid line. Further, an upper ray passing above the light axis and a lower ray passing below the light axis are illustrated by a broken line.

Each of the optical signals transmitted from the plural optical transmission lines 11 enters into the first convex lens 15 with an expansion angle (e.g., 24° in this exemplary embodiment) which is decided by a numerical aperture (NA) of the optical transmission lines 11. Each of the optical signals entering into the first convex lens 15 is refracted at the outside lens face 17 and the inside lens face 18, the light axis (primary ray) thereof is turned (bent), and the collimated optical signals exit the first convex lens 15 and propagate toward the second convex lens 16.

At this time, regarding the optical signals entering into the outside lens face 17 of the first convex lens 15, the farther from the center of the outside lens face 17 with respect to the x-axis direction the optical signal enters into, the greater the turning angle of the light axis is. The closer the optical signal enters into, the smaller the turning angle of the light axis is. Therefore, the light axis of each of the optical signals, which exits from the first convex lens 15 and is collimated, crosses substantially only at one point A between the first convex lens 15 and the second convex lens 16. Further, the upper ray and the lower ray cross substantially only at one point A1 and A2, respectively.

In the second convex lens 16, each of the optical signals collimated by the first convex lens 15 is refracted at the inside lens face 19 and the outside lens face 20, and the light axes of the optical signals are collimated with each other. Each of the optical signals exiting the outside lens face 20 of the second convex lens 16 is focused on a light-receiving end face of each of the photoelectric elements 12.

According to the multi-channel optical communication lens 10 of this exemplary embodiment, since the effective lens diameter is greater than the distance L1 (or L2) between both ends of the optical transmission lines 11 (or photoelectric elements 12) arranged in parallel, the focal length of the optical signal entering into the outside lens face 17 (or exiting the outside lens face 20) is relatively long. Since the focal length is relatively long, a glass window sealing a package can be formed between an LD package or PD package and the lens, and a reliability of the LD or PD can be increased.

Further, an LD package or PD package, which can be used only in case that there is a relatively great distance more than a predetermined distance from the lens, can be used. Still further, since the focal length is relatively long, a light diameter of the optical signal entering into the convex lens becomes greater. Thus, even if there is a flaw or contamination, the optical signal loss can be decreased.

Conventionally, although it has been sufficient that the multi-channel optical communication lens 10 is formed only in view of an aspheric shape of the outside lens faces 17 and 20 so as to form the light path described in FIG. 1, where the effective lens diameter is relatively long (e.g., more than 1 mm), each of the optical signals received at the light-receiving end face of each of the photoelectric elements 12 is not efficiently focused on the light-receiving end face (focal point) due to a spot size thereof being increased by spherical aberration (including a coma aberration and distortion).

In the multi-channel optical communication lens 10 of this exemplary embodiment, even if the effective lens diameter is relatively long, since the inside lens faces 18 and 19 are formed aspherically in addition to the outside lens faces 17 and 20, the spherical aberration occurring at the light-receiving end face can be reduced (canceled).

A refractive power of a lens becomes greater, where the refractive index (n) of the lens is greater and the radius of curvature (r) of the lens is smaller. In this exemplary embodiment, although twelve channels of the optical signals are entered into the lens, a light entering into a location (R) which is farther from the center portion of the lens, must be refracted by a greater refractive power in order to focus each channel of the optical signals on substantially one point.

However, since a spherical aberration (transverse aberration) in a direction perpendicular to the light axis is proportional to the cube of (R/r), where the radius of curvature of the lens is smaller and the refractive power of the lens is greater, the spherical aberration occurs more easily. Therefore, with respect to a light which enters into a location which is farther from the center portion of the lens, the spherical aberration occurs more easily.

According to the preceding focusing property of the lens, where the light is focused in the same focal length, the refractive power at each of the lens faces can be smaller by using four lens faces in this exemplary embodiment, in comparison with the conventional lenses which use two lens faces. That is, the radius of curvature of each lens face can be increased compared to the conventional lenses which use two lens faces.

Therefore, an occurrence of the spherical aberration can be decreased even as to a light which enters into a location which is far from the center portion of the lens such as the optical signals of both ends of the twelve channels.

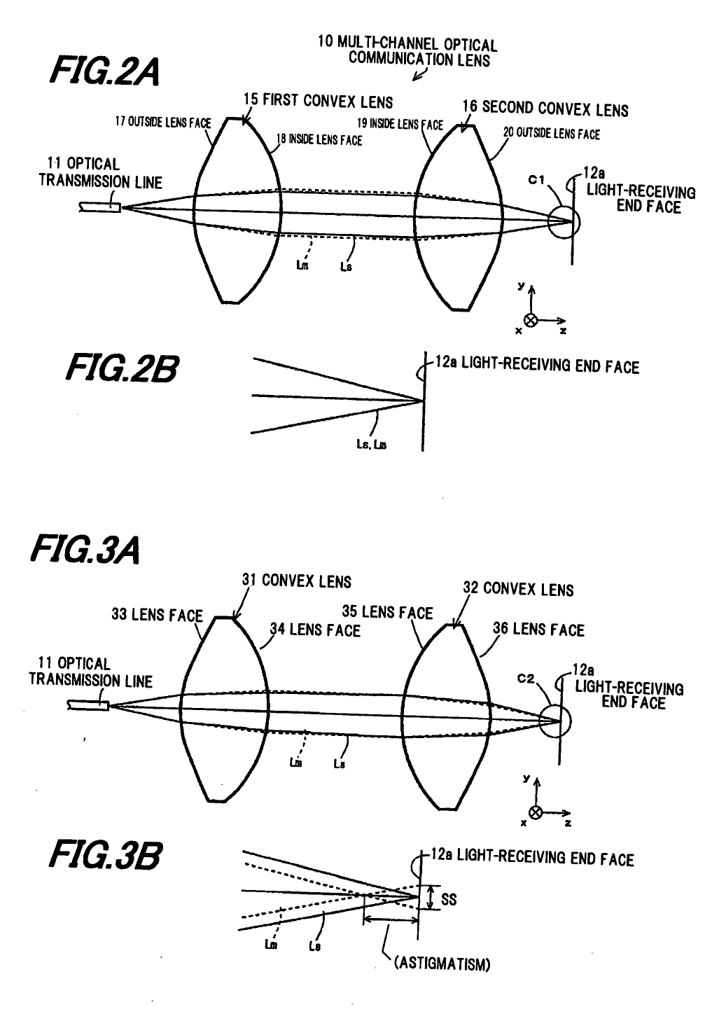

FIG. 2A is a view (pattern diagram showing a spherical segment) taken along a line 2A of FIG. 1, and FIG. 2B is an enlarged view of a part C1 of FIG. 2A.

As shown in FIGS. 2A and 2B, the inside lens faces (the inside lens face 18 of the first convex lens 15 and the inside lens face 19 of the second convex lens 16) facing each other are formed so as to have a nonaxisymmetric aspheric surface (toric surface). Thereby, the astigmatism which occurs where the optical signal is focused on the light-receiving end face 12a of the photoelectric element 12, can be reduced.

FIG. 3A is a pattern diagram showing a spherical segment of a conventional multi-channel optical communication lens, and FIG. 3B is an enlarged view of a part C2 of FIG. 3A.

As shown in FIGS. 3A and 3B, in convex lenses 31 and 32 which include lens faces 34 to 36 having an axisymmetric curved surface, since the optical signals are propagated with arrangement along the x-direction of FIG. 3A, an astigmatism such that focal points of a ray Lm in a meridian plane and a ray Ls in a spherical segment are different back and forth (z-direction in the Figures) in the light axis direction occurs. Therefore, the spot size (SS) at the light-receiving end face 12a becomes much greater (e.g., φ60 μm).

On the other hand, in the multi-channel optical communication lens 10 of this exemplary embodiment of the present invention, the inside lens faces 18 and 19 of the first convex lens 15 and the second convex lens 16 are formed so as to have the nonaxisymmetric aspheric surface. That is, the inside lens faces 18 and 19 are formed to have curved surfaces different from each other with respect to the meridian plane (x-direction) and the spherical segment (y-direction). Thereby, the focal point of the ray Lm and the focal point of the ray Ls can correspond at the light-receiving end face 12a of each photoelectric element 12, and it is possible to collect the light by reducing the astigmatism.

In this exemplary embodiment, although the PD which exemplarily includes the light-receiving diameter of φ50 μm and can perform 10 Gbit/s transmission is used, the spot size of the light-receiving end face is φ18 μm in a constant temperature 25° C., which is sufficiently small with respect to the light-receiving diameter of the PD. Therefore, each of the optical signals can be coupled to the PD array 14.

Further, since the multi-channel optical communication lens 10 is formed of a resin, the spot size will be changed by changing of a refraction index due to a temperature change. However, according to this exemplary embodiment, even if a temperature in the optical module is increased up to 80° C., the spot size can be suppressed to within φ30 μm. Therefore, even if the temperature in the optical module is changed up to 80° C., each of the optical signals can be coupled to the PDs with low optical signal loss.

Therefore, the multi-channel optical communication lens 10 of this exemplary embodiment can reduce the spherical aberration by forming four lens faces 17 to 20 having the aspheric surfaces, reduce the astigmatism by forming the inside lens faces as the toric surfaces, and couple the optical signals to the PDs with low optical signal loss.

Further, when the lens diameter of the multi-channel optical communication lens is more than 1 mm, the increasing of the spot size due to the aberration is negligible. Therefore, the multi-channel optical communication lens 10 of this exemplary embodiment has a remarkable advantage when the lens diameter thereof is more than 1 mm.

Although in this exemplary embodiment the PD for transmission which includes the light-receiving diameter of φ50 μm and can perform 10 Gbit/s transmission is used, when a transmission rate faster than 10 Gbit/s is required, a PD having a smaller light-receiving diameter is needed. That is, a parasitic capacitance arising in the PD becomes greater and a frequency band becomes narrower according to a size of the light-receiving diameter of the PD. This exemplary embodiment can be applied to a PD having a light-receiving diameter of φ30 μm or an optical module having a transmission rate faster than 10 Gbit/s.

Although in FIG. 1, an exemplary light-receiving element is defined as the photoelectric element 12 and the light outputted from the optical transmission line 11 is received by the light-receiving element is described, the same operation and effect can be obtained even when the photoelectric element 12 is used as a light-emitting element and the light outputted from the light-emitting element is focused on the end face of the optical transmission lines 11 (optical fiber) or a vicinity thereof through the multi-channel optical communication lens 10. In this case, the vicinity of the end face means an area where light coupling loss is less than a desired loss when the optical signals are coupled to the optical transmission lines 11.

The laser diode (LD) is exemplarily used as the light-emitting element, and the LD array is exemplarily used as the plural light-emitting elements arranged. Especially, a vertical-cavity surface-emitting laser (VCSEL) array may be used as the LD array. In this case, although a plurality of optical signals outputted from the photoelectric elements 12 are transmitted in a direction opposite to that in FIG. 1, the same operation and effect can be obtained.

In the multi-channel optical communication lens 10 of this exemplary embodiment, the outside lens face 17 of the first convex lens 15 and the outside lens face 20 of the second convex lens 16 are formed to have the same curved surface, and the inside lens face 18 of the first convex lens 15 and the inside lens face 19 of the second convex lens 16 are formed to have the same curved surface. Therefore, it is necessary only to design both of the convex lenses 15 and 16 so that a light path of each of the optical signals from the optical transmission lines 11 to the point A and a light path of each of the optical signals from the photoelectric elements 12 to the point A can be symmetrical with respect to the point A. Thus, it is easy to design a lens.

Further, since the convex lens 15 and 16 can be formed by the same metal mold, the convex lens 15 and 16 can be manufactured with low cost.

Although in this exemplary embodiment, the multi-channel optical communication lens 10 is described by the outside lens surface having the aspheric surface and the inside lens face having the aspherical toric surface, a deposition of each of the lens faces is not limited to this.

Further, although in this exemplary embodiment, the first convex lens 15 and the second convex lens 16 are formed to have the same shape, the inside lens faces 17 and 18 can be different from each other if they are designed so as to decrease an aberration.

Although the invention has been described with respect to specific exemplary embodiments for complete and clear disclosure, the appended claims are not to be thus limited but are to be construed as embodying all modifications and alternative constructions that may occur to one skilled in the art which fairly fall within the basic teaching herein set forth.

Further, it is noted that Applicant's intent is to encompass equivalents of all claim elements, even if amended later during prosecution.

What is claimed is:

1. A multi-channel optical communication lens system, which is disposed between a plurality of arranged optical transmission lines and a plurality of photoelectric elements which are arranged facing respective ones of said optical transmission lines and transmit or receive optical signals, and which couples the optical signals between each of said optical transmission lines and each of said photoelectric elements thereto respectively, said lens system comprising:
a first convex lens disposed at a location which makes the optical signals focus on end faces of said arranged optical transmission lines or a vicinity thereof; and
a second convex lens disposed at a location which makes the optical signals focus on said photoelectric elements,
wherein both of said first and second convex lenses comprise an aspherical surface on one side thereof and a nonaxisymmetric aspherical surface on another side thereof.

2. The multi-channel optical communication lens system according to claim 1, wherein:
at least one of said first convex lens and said second convex lens collimates said optical signals outputted from said arranged optical transmission lines, crosses the optical signals substantially at one point between said first convex lens and said second convex lens, and focuses the optical signals on said photoelectric elements.

3. The multi-channel optical communication lens system according to claim 1, wherein:
at least one of said first convex lens and said second convex lens collimates the optical signals outputted from said photoelectric elements, crosses the optical signals substantially at one point between said first convex lens and said second convex lens, and focuses the optical signals on an end face of said optical transmission lines or a vicinity thereof.

4. The multi-channel optical communication lens system according to claim 1, wherein:
a lens face at a side of said optical transmission lines of the first convex lens and the lens face at a side of the photoelectric elements of said second convex lens are formed to have a same curved surface, and the lens face at an opposite side of said optical transmission lines of said first convex lens and the lens face at an opposite side of said photoelectric elements of said second convex lens are formed to have a same curved surface.

5. The multi-channel optical communication lens system according to claim 1, wherein:
said first convex lens and said second convex lens are substantially identically formed.

6. The multi-channel optical communication lens system according to claim 1, wherein:
said first convex lens includes an effective lens diameter greater than a distance of both ends of said optical transmission lines which are most distant from each other with respect to said plural optical transmission lines arranged in parallel, and said second convex lens includes an effective lens diameter greater than a distance of the both ends of said plural optical photoelectric elements which are most distant from each other with respect to said plural optical photoelectric elements arranged in parallel.

7. An optical module, comprising:
a plurality of arranged optical transmission lines;
a plurality of photoelectric elements which is arranged facing respective ones of said optical transmission lines and transmit or receive optical signals;
a first convex lens disposed at a location which makes the optical signals focus on end faces of said arranged optical transmission lines or a vicinity thereof, and
a second convex lens disposed at a location which makes the optical signals focus on said photoelectric elements,
wherein both of said first and second convex lenses comprise an aspherical surface on one side thereof and a nonaxisymmetric aspherical surface on another side thereof.

8. The optical module according to claim 7, wherein:
at least one of said first convex lens and said second convex lens collimates the optical signals outputted from said arranged optical transmission lines, crosses the optical signals substantially at one point between said first convex lens and said second convex lens, and focuses the optical signals on said photoelectric elements.

9. The optical module according to claim 7, wherein:
at least one of said first convex lens and said second convex lens collimates the optical signals outputted from said photoelectric elements, crosses the optical signals substantially at one point between said first convex lens and said second convex lens, and focuses the optical signals on an end face of said optical transmission lines or a vicinity thereof.

10. The optical module according to claim 7, wherein:
a lens face at a side of said optical transmission lines of the first convex lens and the lens face at a side of the photoelectric elements of said second convex lens are formed to have a same curved surface, and the lens face at an opposite side of said optical transmission lines of said first convex lens and the lens face at an opposite side of said photoelectric elements of said second convex lens are formed to have a same curved surface.

11. The optical module according to claim 7, wherein:
said first convex lens and said second convex lens are substantially identically formed.

12. The optical module according to claim 7, wherein:
said first convex lens includes an effective lens diameter greater than a distance of both ends of said optical transmission lines which are most distant from each other with respect to said plural optical transmission lines arranged in parallel, and said second convex lens includes an effective lens diameter greater than a distance of the both ends of said plural optical photoelectric elements which are most distant from each other with respect to said plural optical photoelectric elements arranged in parallel.

13. A multi-channel optical communication lens system, which is disposed between a plurality of arranged optical transmission lines and a plurality of photoelectric elements which are arranged facing respective ones of said optical transmission lines and transmit or receive optical signals, and which couples the optical signals between each of said optical transmission lines and each of said photoelectric elements thereto respectively, said lens system comprising:
first means, disposed at a location for making the optical signals focus on end faces of said arranged optical transmission lines or a vicinity thereof; and
second means, disposed at a location for making the optical signals focus on said photoelectric elements,
wherein both of said first and second means comprise an aspherical surface on one side thereof and a nonaxisymmetric aspherical surface on another side thereof.

14. The multi-channel optical communication lens system according to claim 13, wherein:
at least one of said first means and said second means collimates said optical signals outputted from said arranged optical transmission lines, crosses the optical signals substantially at one point between said first means and said second means, and focuses the optical signals on said photoelectric elements.

15. The multi-channel optical communication lens system according to claim 13, wherein:
at least one of said first means and said second means collimates the optical signals outputted from said photoelectric elements, crosses the optical signals substantially at one point between said first means and said second means, and focuses the optical signals on an end face of said optical transmission lines or a vicinity thereof.

16. The multi-channel optical communication lens system according to claim 13, wherein:
a face at a side of said optical transmission lines of the first means and a face at a side of the photoelectric elements of said second means are formed to have a same curved surface, and a face at an opposite side of said optical transmission lines of said first means and a lens face at an opposite side of said photoelectric elements of said second means are formed to have a same curved surface.

17. The multi-channel optical communication lens system according to claim 13, wherein:
said first means and said second means are substantially identically formed.

18. The multi-channel optical communication lens system according to claim 13, wherein:
said first means includes a convex lens having an effective lens diameter greater than a distance of both ends of said optical transmission lines which are most distant from each other with respect to said plural optical transmission lines arranged in parallel, and said second means includes a convex lens having an effective lens diameter greater than a distance of the both ends of said plural optical photoelectric elements which are most distant from each other with respect to said plural optical photoelectric elements arranged in parallel.
